(19) United States
(12) Patent Application Publication
(10) Pub. No.: US 2007/0055806 A1
(43) Pub. Date: Mar. 8, 2007

(54) Adapting legacy instruments to an instrument system based on synchronized time

(76) Inventors: John Bruce Stratton, Santa Rosa, CA (US); Leon Kenneth Werenka, Mukilteo, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/219,248

(22) Filed: Sep. 2, 2005

(51) Int. Cl. G06F 13/36

(52) U.S. Cl. 710/312

(57) ABSTRACT

A legacy interface module that enables legacy instruments to function in instrument systems based on synchronized time. A legacy instrument module according to the present teachings adapts a legacy interface of a legacy instrument to an instrument system based on synchronized time without modifications to the legacy instrument.

### BACKGROUND

Instrument systems may be employed in a wide variety of applications including test and measurement, manufacturing, industrial control, and environmental monitoring, to name just a few examples. Examples of instruments in an instrument system include measurement instruments, actuator instruments, control instruments, computational devices, etc.

An action involving an instrument in an instrument system may be referred to as an instrument action. One example of an instrument action is obtaining a measurement of an object of interest. Another example of an instrument action is applying a stimulus to an object of interest.

An instrument system may include synchronized clocks for coordinating instrument actions. An instrument system that uses synchronized clocks to coordinate instrument actions may be referred to as an instrument system based on synchronized time.

An instrument system based on synchronized time may include a set of instruments connected to a communication network. Each instrument on the communication network may include a local clock. The local clocks in the instruments may be synchronized to provide a system-wide time-of-day for coordinating instrument actions.

An instrument that is adapted to function in an instrument system based on synchronized time may include mechanisms for coordinating instrument actions using the system-wide time-of-day of the instrument system. For example, an instrument that is adapted to function in an instrument system based on synchronized time may include a local clock and a mechanism for synchronizing the local clock to the system-wide time-of-day and mechanisms for coordinating its actions using its local clock.

A vast number of instruments may still exist that are not adapted to function in an instrument system based on synchronized time. For example, a vast number of instruments were designed and built before the advent of instrument systems based on synchronized time. An instrument that is not adapted an instrument system based on synchronized time may be referred to as a legacy instrument.

A designer of an instrument system who seeks the advantages of an advanced design based on synchronized time may be faced with the immediate obsolescence of their legacy instruments. Unfortunately, the costs of replacing legacy instruments with new instruments that are adapted to function in an instrument system based on synchronized time may be extremely expensive.

### SUMMARY OF THE INVENTION

A legacy interface module is disclosed that enables legacy instruments to function in instrument systems based on synchronized time. A legacy instrument module according to the present teachings adapts a legacy interface of a legacy instrument to an instrument system based on synchronized time without modifications to the legacy instrument.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows an instrument system that incorporates the present teachings;

FIG. 2 shows a legacy interface module in one embodiment.

### DETAILED DESCRIPTION

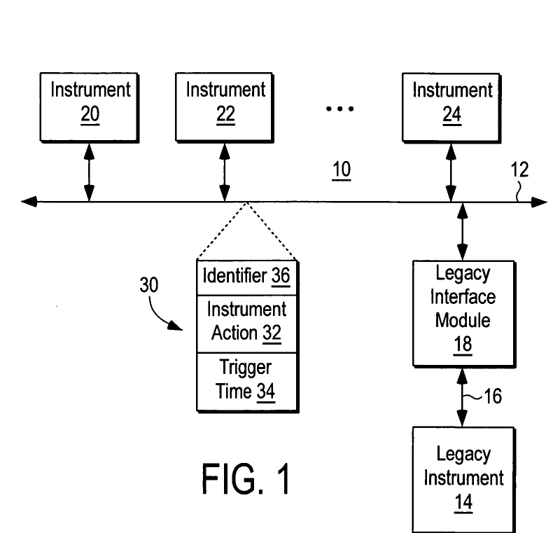

FIG. 1 shows an instrument system 10 that incorporates the present teachings. The instrument system 10 is an instrument system based on synchronized time. The instrument system 10 includes a set of instruments 20-24 that communicate via a communication network 12. The communication network 12 may be a local area network, e.g. Ethernet.

Each instrument 20-24 includes a local clock and the instruments 20-24 engage in a clock synchronization protocol for maintaining a synchronized time-of-day in the local clocks of the instruments 20-24. In one embodiment, the instruments 20-24 maintain synchronized time by exchanging messages via the communication network 12 time according to the IEEE 1588 protocol.

Instrument actions in the instrument system 10 are specified using messages carried on the communication network 12. For example, a message 30 on the communication network 12 specifies an instrument action 32 and a trigger time 34. The message 30 in this embodiment also includes an identifier 36 of an instrument or instruments that are to perform the instrument action 32 at the trigger time 34 in response to the message 30.

The instrument system 10 includes a legacy interface module 18 that enables a legacy instrument 14 to function in the instrument system 10 according to the present teachings. The legacy interface module 18 enables the legacy instrument 14 to function in the instrument system 10 even though the legacy instrument 14 is not adapted to an instrument system based on synchronized time. For example, the legacy instrument 14 may not include mechanisms for triggering a instrument action in response to the message 30.

Instead, the legacy instrument 14 is adapted to perform instrument actions in response to signals carried on a legacy interface 16. For example, the legacy interface 16 may include command lines and trigger lines. The command lines of the legacy interface 16 may specify an instrument action. A trigger line of the legacy interface 16 may trigger the instrument 14 to perform the instrument action.

The legacy interface module 18 includes mechanisms for communicating with the legacy instrument 14 via the legacy interface 16 and mechanisms for communicating with the remainder of instrument system 10 via the communication network 12. The legacy interface module 18 further includes mechanisms for adapting the legacy interface 16 to the instrument system 10 so that the legacy instrument 14 functions in the instrument system 10 based on synchronized time. For example, the legacy interface module 18 obtains the message 30 via the communication network 12 and triggers the legacy instrument 14 to perform the instrument action 32 at the trigger time 34 if the identifier 36 corresponds to the legacy instrument 14.

The legacy interface 16 may include a standard interface to the instrument 14. Examples of standard interfaces include IEEE 488, USB, RS-232, IEEE 1394, etc. The legacy interface 16 may include a local area network connection that is adapted for communication with instruments.

The legacy interface 16 may include one or more trigger lines for triggering particular actions in the legacy instrument 14. For example, the legacy interface 16 may include a trigger line for carrying a trigger pulse that causes the legacy instrument 14 to obtain a measurement, or to start obtaining a series of measurements, or to stop obtaining measurements, or to apply a stimulus to a device under test, etc.

The legacy interface module 18 may include mechanisms for sensing which legacy interface is connected. For example, the legacy interface module 18 may include mechanisms for sensing an IEEE 488 connection, a USB connection, an RS-232 connection, an IEEE 1394 connection, etc. The legacy interface module 18 may adapt its communication with the legacy instrument 14 accordingly.

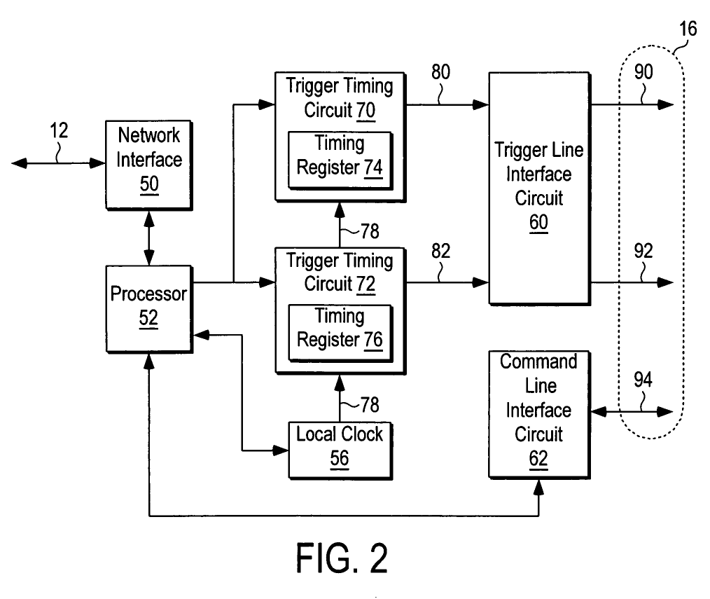

FIG. 2 shows the legacy interface module 18 in one embodiment. The mechanisms in the legacy interface module 18 for communicating with the legacy instrument 14 via the legacy interface 16 and for communicating with the remainder of instrument system 10 via the communication network 12 and for adapting the legacy interface 16 to the instrument system 10 in this embodiment include a trigger line interface circuit 60, a command line interface circuit 62, a network interface 50, a processor 52 and associated software/firmware, a set of trigger timing circuits 70-72, and a local clock 56.

The network interface 50 enables communication via the communication network 12. For example, if the communication network 12 is Ethernet then the network interface 50 is adapted for Ethernet communication including a physical media interface, media access controller, protocol stack, etc.

The processor 52 maintains a synchronized time-of-day in the local clock 56 by exchanging timing messages with a master clock via the communication network 12. The master clock may be a clock in one of the instruments 20-24 or may be a clock in another node on the communication network 12. In one embodiment, the processor 52 maintains a synchronized time-of-day in the local clock 56 according to the IEEE 1588 synchronization protocol. In some embodiments, the local clock 56 may function as a master clock for the instrument system 10.

The trigger line interface circuit 60 drives a set of trigger lines 90-92 on the legacy interface 16 in response to a set of respective trigger signals 80-82 generated by the respective trigger timing circuits 70-72. The trigger line interface circuit 60 is adapted to the physical implementation of the trigger lines 90-92 for the legacy instrument 14. For example, the trigger line interface circuit 60 provides the appropriate voltage, current levels, and timing for trigger signals to the legacy instrument 14.

The command line interface circuit 62 drives a set of command lines 94 on the legacy interface 16 in response to commands from the processor 52. The command line interface circuit 62 is adapted to the physical implementation of the command lines 94 of the legacy instrument 14. For example, the command line interface circuit 62 may be adapted to a standard interface of the command lines 94, e.g. IEEE 488, USB, RS-232, or IEEE 1394, depending on the needs of the legacy instrument 14.

The network interface 50 obtains the message 30 via the communication network 12 and provides the contents of the message 30 to the processor 52. The network interface 50 may determine whether the identifier 36 in the message 30 is targeted at the legacy instrument 14. Alternatively, the processor 52 may determine whether the identifier 36 is targeted at the legacy instrument 14. For example, the identifier 36 may correspond to a network address allocated to the legacy instrument 14. Alternatively, the identifier 36 may specify a class of instruments to which the legacy instrument 14 may belong.

The processor 52 maps the instrument action 32 in the message 30 to one of the trigger timing circuits 70-72. For example, if the instrument action 32 corresponds to a measurement action of the legacy instrument 14 that is triggered using the trigger line 90 then the processor 52 maps the instrument action 32 to the trigger timing circuit 70 and writes the trigger time 34 from the message 30 into a timing register 74 in the trigger timing circuit 70. Similarly, if the instrument action 32 corresponds to a measurement action of the legacy instrument 14 that is triggered using the trigger line 92 then the processor 52 maps the instrument action 32 to the trigger timing circuit 72 and writes the trigger time 34 into a timing register 76 in the trigger timing circuit 72.

The trigger timing circuit 70 compares the time in the timing register 74 to a time 78 of the local clock 56 and issues the trigger signal 80 to the trigger line interface circuit 60 when the time in the timing register 74 matches the time 78. In response to the trigger signal 80, the trigger line interface circuit 60 drives a trigger signal onto the trigger line 90, thereby triggering an instrument action of the legacy instrument 14. Similarly, the trigger timing circuit 72 issues the trigger signal 82 to the trigger line interface circuit 60 when the time in the timing register 76 matches the time 78 and in response the trigger line interface circuit 60 drives a trigger signal onto the trigger line 92 to trigger an instrument action of the legacy instrument 14.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A legacy interface module that adapts a legacy instrument to an instrument system based on synchronized time.

2. The legacy interface module of claim 1, comprising:
first interface circuit that communicates with the legacy instrument via a legacy interface;
second interface circuit that communicates with the instrument system via a communication network;
circuitry that adapts the legacy interface to the instrument system.

3. The legacy interface module of claim 2, wherein the circuitry that adapts the legacy interface comprises:
synchronized clock;
circuit for generating a trigger signal on the legacy interface in response to a message received via the communication network and a time-of-day in the synchronized clock.

4. The legacy interface module of claim 3, wherein the circuit for generating a trigger signal generates the trigger signal when the time-of-day in the synchronized clock matched a time-of-day specified in the message.

5. The legacy interface module of claim 4, wherein the circuit for generating a trigger signal generates the trigger signal in response to an instrument action specified in the message.

6. An instrument system, comprising:
a set of instruments that are adapted to coordinate an instrument action based on synchronized time;
legacy instrument that performs the instrument action in response to a signal on a legacy interface;
legacy interface module that adapts the legacy instrument to the instruments that coordinate based on synchronized time.

7. The instrument system of claim 6, wherein the legacy interface module comprises:
first interface circuit that communicates with the legacy instrument via the legacy interface;
second interface circuit that communicates with the instruments that coordinate based on synchronized time via a communication network;
circuitry that adapts the legacy interface to the instruments that coordinate based on synchronized time.

8. The instrument system of claim 7, wherein the circuitry that adapts comprises:
synchronized clock;
circuit for generating the trigger signal on the legacy interface in response to a message received via the communication network and a time-of-day in the synchronized clock.

9. The instrument system of claim 8, wherein the circuit for generating the trigger signal generates the trigger signal when the time-of-day in the synchronized clock matches a time-of-day specified in the message.

10. The instrument system of claim 9, wherein the circuit for generating the trigger signal generates the trigger signal in response to the instrument action specified in the message.

11. A method for adapting a legacy instrument to an instrument system based on synchronized time, comprising:
communicating with the legacy instrument via a legacy interface;
communicating with the instrument system via a communication network;
adapting the legacy interface to the instrument system.

12. The method of claim 11, wherein adapting the legacy interface comprises:
generating a synchronized local time for the legacy instrument;
generating a trigger signal on the legacy interface in response to a message received via the communication network and the synchronized local time.

13. The method of claim 12, wherein generating the trigger signal includes generating the trigger signal when the synchronized local time matches a time-of-day specified in the message.

14. The method of claim 13, wherein generating the trigger signal includes generating the trigger signal in response to an instrument action specified in the message.
